(19) United States
(12) Patent Application Publication
(10) Pub. No.: US 2026/0171718 A1
(43) Pub. Date: Jun. 18, 2026

(54) CONNECTOR

(71) Applicant: YAZAKI CORPORATION, Tokyo (JP)

(72) Inventor: Naoto Takashima, Makinohara-shi (JP)

(21) Appl. No.: 19/420,687

(22) Filed: Dec. 15, 2025

(30) Foreign Application Priority Data
Dec. 16, 2024 (JP) 2024-219715

(51) Int. Cl. H01R 13/629

(52) U.S. Cl. CPC H01R 13/62938; H01R 13/62955

(57) ABSTRACT

In a connector, a first side plate of a lever includes, at one end side, a temporary locking arm and a deflection restricting portion. The temporary locking arm enables rotation of the lever when an arm portion deflects toward a second side plate, and a protrusion is disengaged from a locking portion. The deflection restricting portion includes a deflection restricting surface contacting with the arm portion of the temporary locking arm deformed by application of an external force to the lever positioned at the initial position. The deflection restricting surface is inclined so that an interval between the deflection restricting surface and the arm portion is increased as the deflection restricting surface is separated from the second side plate along a direction in which the first side plate and the second side plate face each other.

### CROSS REFERENCE TO RELATED APPLICATION

The present application is based on, and claims priority from the Japanese Patent Application No. 2024-219715, filed on Dec. 16, 2024, the entire contents of which are incorporated herein by reference.

### TECHNICAL FIELD

The present disclosure relates to a connector.

### BACKGROUND

In the related art, there is a lever-type connector in which a lever is rotatably supported by a connector main body, and the connector main body and a mating connector are brought close to each other and fitted together by rotation of the lever. JP 2024-65559 A discloses a technique relating to a connector in which a temporary locking arm is formed at a part of a lever so that the lever can be shipped or transported in a state of being held at an initial position. In the connector, a deflection restricting portion that is arranged adjacent to the temporary locking arm and includes a facing portion and a vertical portion is provided on one side plate of a pair of side plates forming the lever. With this, when an unintended external force is applied to the lever positioned at the initial position, the temporary locking arm deformed by the external force abuts against a corner portion at which the facing portion and the vertical portion of the deflection restricting portion intersect with each other, thereby restricting an arm portion of the temporary locking arm from deflecting toward the other side plate.

### SUMMARY OF THE INVENTION

In the connector disclosed in JP 2024-65559 A, the deflection restricting portion includes the facing portion and the vertical portion. However, in order to avoid complication of the shape of the lever in which the deflection restricting portion is provided, there is room for further improvement.

An object of the present disclosure is to provide a connector that suppresses release of temporary locking due to application of an unintended external force to a lever held at an initial position by a temporary locking arm, with a simpler shape of the lever.

A connector according to an aspect of an embodiment includes a connector main body that includes at least an inner housing and a front mask accommodating the inner housing, and a lever that is rotatably supported by the inner housing, and brings the connector main body close to and fits the connector main body to a mating connector by rotating from an initial position to a fitting-completion position, wherein the lever includes a first side plate and a second side plate that each include a rotation fulcrum portion at one end side, position the inner housing therebetween, and each have an arm-like shape, and an operation portion that couples the other end of the first side plate and the other end of the second side plate to each other, the front mask includes an opening portion from which the one end of the first side plate entering a space between the front mask and the inner housing is exposed outside, the first side plate includes, at the one end side, a temporary locking arm that includes an arm portion deflecting toward the second side plate and a protrusion protruding from a free end of the arm portion to a side opposite to the second side plate, restricts rotation of the lever when the protrusion abuts against a locking portion provided to the opening portion of the front mask while the lever is positioned at the initial position, and enables rotation of the lever when the arm portion deflects toward the second side plate, and the protrusion is disengaged from the locking portion, and a deflection restricting portion that includes a deflection restricting surface contacting with the arm portion of the temporary locking arm deformed by application of an external force to the lever positioned at the initial position, and the deflection restricting surface is inclined so that an interval between the deflection restricting surface and the arm portion is increased as the deflection restricting surface is separated from the second side plate along a direction in which the first side plate and the second side plate face each other.

According to the above-mentioned configuration, it is possible to provide a connector that suppresses release of temporary locking due to application of an unintended external force to a lever held at an initial position by a temporary locking arm, with a simpler shape of the lever.

### BRIEF DESCRIPTION OF THE DRAWINGS

FIG. 1 is an exploded perspective view of a connector according to an embodiment.

FIG. 2 is a perspective view of the connector according to the embodiment in an assembled state.

FIG. 3 is a perspective view of the connector according to the embodiment in a shipping state.

FIG. 4 is a perspective view of a lever.

FIG. 5 is a side view of the lever.

FIG. 6 is a bottom view of a part of the lever.

FIG. 7 is a side view of the connector when the lever is held at an initial position.

FIG. 8A is a bottom view of the connector when the lever is held at the initial position.

FIG. 8B is an enlarged view of a part of the connector that corresponds to the part VIIIB in FIG. 8A.

FIG. 9 is a side view of the connector when an external force is applied to the lever.

FIG. 10A is a bottom view of the connector when an external force is applied to the lever.

FIG. 10B is an enlarged view of a part of the connector that corresponds to the part XB in FIG. 10A.

### DETAILED DESCRIPTION OF THE INVENTION

With reference to the drawings, a connector according to an embodiment is described below in detail. Note that the dimensional ratios in the drawings are exaggerated for explanatory purposes, and may differ from the actual ratios.

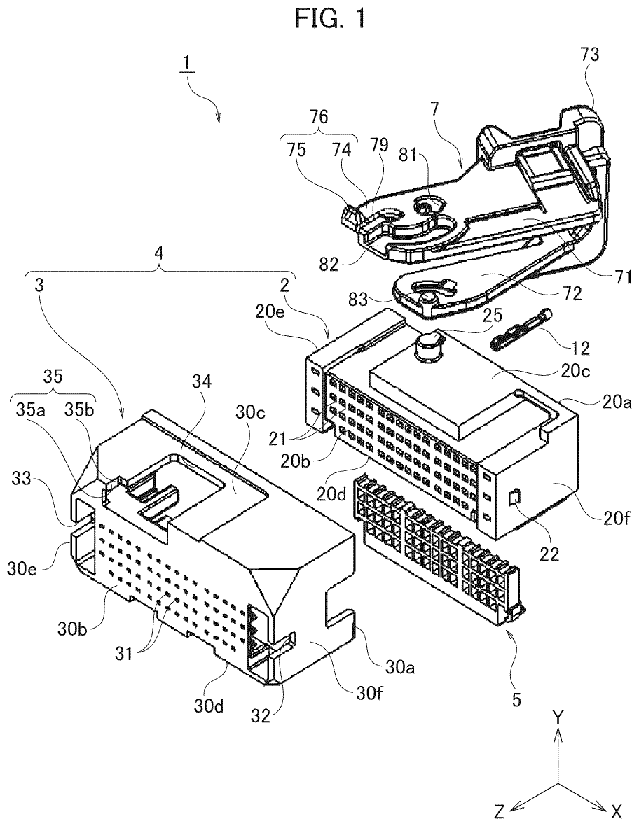

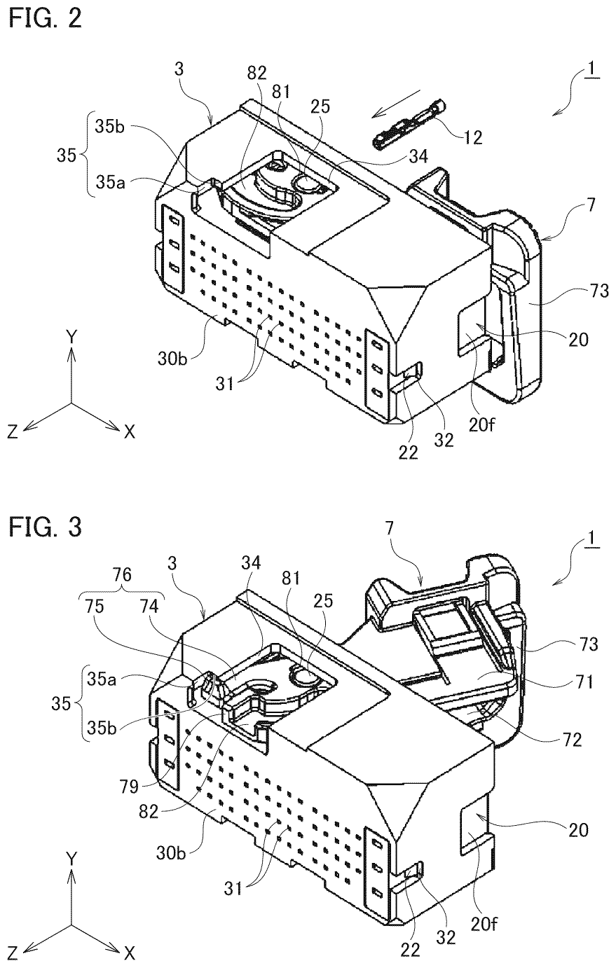

FIG. 1 is an exploded perspective view of a connector 1 according to an embodiment. FIG. 2 is a perspective view of the connector 1 in an assembled state. FIG. 3 is a perspective view of the connector 1 in a shipping state.

The connector 1 includes a connector main body 4, a spacer 5, and a lever 7, and is a so-called lever-type connector in which the connector main body 4 and a mating connector (not illustrated) are brought close to each other and fitted together by rotation of the lever 7. Hereinafter, a direction in which the connector main body 4 is fitted to the mating connector (hereinafter referred to as a “fitting direction”) corresponds to a Z direction in the drawings. Further, the Z direction is regarded as a vertical direction, and a part located upstream may be referred to as “upper”, and a part located downstream may be referred to as “bottom”. Further, two directions that are orthogonal to the fitting direction and also orthogonal to each other are defined as an X direction and a Y direction, respectively.

The connector main body 4 includes an inner housing 2 and a front mask 3.

The inner housing 2 accommodates a plurality of terminals 12 each of which is connected to a terminal end of an electric wire (not illustrated). In the present embodiment, the terminal 12 is a female terminal. FIG. 2 illustrates the connector 1 when one terminal 12 is assembled to the connector main body 4 on which the lever 7 is mounted. The inner housing 2 is formed of a synthetic resin, and has a substantially rectangular parallelepiped shape including an upper surface 20a, a bottom surface 20b, and four side surfaces, specifically, a first side surface 20c, a second side surface 20d, a third side surface 20e, and a fourth side surface 20f. In the inner housing 2, a plurality of accommodation portions 21 each of which accommodates one terminal 12 are formed.

The upper surface 20a is provided with one opening of each of the accommodation portions 21, and is a surface through which the terminal 12 is accommodated in the accommodation portion 21. The bottom surface 20b is opposite to the upper surface 20a in the Z direction, is provided with the other opening of each of the accommodation portions 21, and is a surface through which a part of a mating terminal connected to the terminal 12 is inserted.

The first side surface 20c is a surface provided with a first rotation fulcrum receiving portion 25 with which a first rotation fulcrum portion 81 of the lever 7 is slidably engaged. In the present embodiment, the first rotation fulcrum portion 81 is a through-hole portion whereas the first rotation fulcrum receiving portion 25 is a cylindrical portion. The second side surface 20d is on a side opposite to the first side surface 20c in a direction opposite to the Y direction, and is a surface provided with a second rotation fulcrum receiving portion (not illustrated) with which a second rotation fulcrum portion 83 of the lever 7 is slidably engaged. In the present embodiment, the second rotation fulcrum portion 83 is a cylindrical portion whereas the second rotation fulcrum receiving portion is a hole portion. The center axis of the first rotation fulcrum receiving portion 25 and the center axis of the second rotation fulcrum receiving portion are on the same axis along the Y direction.

The third side surface 20e is a surface provided with a second locking protrusion (not illustrated) that is locked to a second locking hole portion 33 of the front mask 3. The fourth side surface 20f is on a side opposite to the third side surface 20e in the X direction, and is a surface provided with a first locking protrusion 22 that is locked to a first locking hole portion 32 of the front mask 3.

The front mask 3 accommodates the inner housing 2. The front mask 3 is formed of a synthetic resin, and has a box-like shape including a bottom wall 30b and four side walls, specifically, a first side wall 30c, a second side wall 30d, a third side wall 30e, and a fourth side wall 30f.

The bottom wall 30b includes a plurality of through holes 31 for allowing a male terminal of the mating connector to pass through the accommodation portion 21 of the inner housing 2. In the front mask 3, a part that faces the bottom wall 30b in a direction opposite to the Z direction corresponds to an accommodation port 30a that receives the inner housing 2.

When the inner housing 2 is accommodated in the front mask 3, the first side wall 30c faces the first side surface 20c of the inner housing 2. In the first side wall 30c and the bottom wall 30b, an opening portion 34 is formed so that a part of the first side wall 30c and a part of the bottom wall 30b are integrally notched. From the opening portion 34, the one end of the first side plate 71 of the lever 7 that enters a space between the front mask 3 and the inner housing 2 is exposed outside. Further, a part of the opening portion 34 is provided with a locking portion 35 that restricts rotation of the lever 7 by causing a protrusion 75 of the temporary locking arm 76 to abut against the locking portion 35 when the lever 7 is positioned at an initial position. Note that the initial position of the lever 7 is described below in detail. The locking portion 35 has a shape obtained by further notching a part of a side edge portion of the opening portion 34, and includes a first edge portion 35a defined as the YZ plane having the X direction as a normal direction and a second edge portion 35b defined as the XY plane having the Z direction as a normal direction in the present embodiment. The first edge portion 35a faces a side edge portion on an opposite side in the X direction with the opening of the opening portion 34 interposed therebetween. The second edge portion 35b extends outward in the Z direction. The second side wall 30d is on a side opposite to the first side wall 30c in a direction opposite to the Y direction, and faces the second side surface 20d of the inner housing 2 when the inner housing 2 is accommodated in the front mask 3.

The third side wall 30e includes the second locking hole portion 33 that is locked to the second locking protrusion (not illustrated) of the inner housing 2. The fourth side wall 30f is on a side opposite to the third side wall 30e in the X direction, and includes the first locking hole portion 32 that is locked to the first locking protrusion 22 of the inner housing 2.

The spacer 5 is formed of a synthetic resin, and is a plate-like member for doubly locking the plurality of terminals 12. When the lever 7 is positioned at a fitting-completion position, the plurality of terminals 12 are accommodated in the accommodation portions 21 while the spacer 5 is temporarily locked to the inner housing 2. After each of the terminals 12 is accommodated in the accommodation portion 21, the spacer 5 is primarily locked to the inner housing 2. Then, the lever 7 is returned to the initial position, and the connector 1 is finally in a shipping state illustrated in FIG. 3. Note that the fitting-completion position of the lever 7 is described below in detail as well as the initial position.

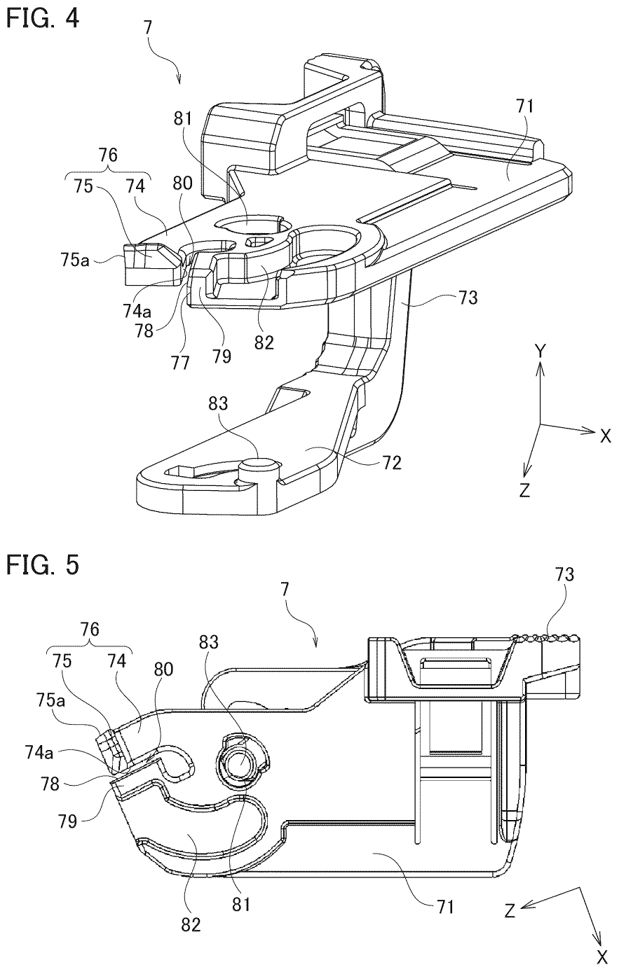

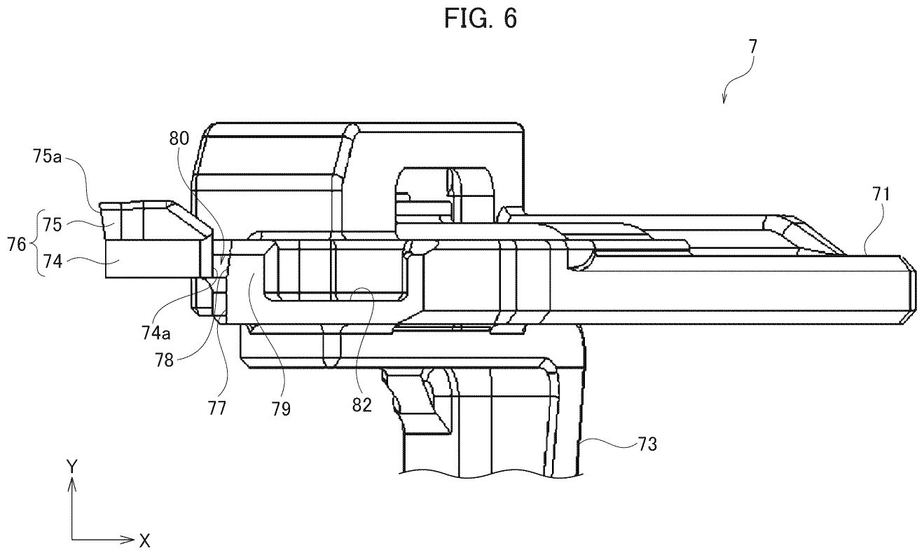

FIG. 4 is a perspective view of the lever 7. FIG. 5 is a side view of the lever 7 as viewed in a direction opposite to the Y direction. FIG. 6 is a bottom view of a part of the lever 7 as the first side plate 71 is viewed in a direction opposite to the Z direction. The respective directions X, Y, and Z in FIG. 4, FIG. 5, and FIG. 6 correspond to a case in which the lever 7 is positioned at the initial position.

The lever 7 is rotatably supported by the connector main body 4, and brings the connector main body 4 close to and fits the connector main body 4 to the mating connector by rotating from the initial position to the fitting-completion position.

Herein, the initial position of the lever 7 indicates a position at which the connector 1 is maintained in a certain state of not being connected to the mating connector, for example, a state where the connector 1 is in a shipping state. In the connector 1 illustrated in FIG. 3, the lever 7 is at the initial position. Further, a state of the lever 7 held at the initial position may also be referred to as a “temporary locking state”.

In contrast, the fitting-completion position of the lever 7 indicates a position at which fitting of the connector main body 4 with respect to the mating connector is completed. In the connector 1 illustrated in FIG. 2, which illustrates an assembling step of the terminal 12, although fitting with respect to the mating connector is not completed, the position of the lever 7 corresponds to the fitting-completion position. Further, a state of the lever 7 held at the fitting-completion position may also be referred to as a “primary locking state”.

The lever 7 is formed of a synthetic resin, and includes a first side plate 71, a second side plate 72, and an operation portion 73. The first side plate 71 and the second side plate 72 each include the rotation fulcrum portion at the one end side, and each have an arm-like shape with the inner housing 2 positioned therebetween. The first side plate 71 and the second side plate 72 are arranged in parallel to each other in the Y direction, and the inner housing 2 is positioned therebetween. In particular, when the connector 1 is assembled, a part including the one end of the first side plate 71 enters a space between the inner housing 2 and the front mask 3. The rotation fulcrum portion provided on the one end side of the first side plate 71 is the first rotation fulcrum portion 81 being a through-hole portion. The rotation fulcrum portion provided on the one end side of the second side plate 72 is the second rotation fulcrum portion 83 being a cylindrical portion. The center axis of the first rotation fulcrum portion 81 and the center axis of the second rotation fulcrum portion 83 are on the same axis along the Y direction. The operation portion 73 couples the other end of the first side plate 71 and the other end of the second side plate 72 to each other, and is operated when an operator rotates the lever 7.

The first side plate 71 includes, at the one end side, a cam groove 82, a temporary locking arm 76, and a deflection restricting portion 79.

When the connector 1 is fitted to the mating connector, a cam protrusion of the mating connector enters the cam groove 82. The cam groove 82 has a shape that is opened, in the first side plate 71, at least on a side opposite to a side facing the second side plate 72, and that is opened toward the Z direction when the lever 7 is at the initial position. When fitting of the connector 1 to the mating connector is started while the lever 7 is held at the initial position, the cam protrusion of the mating connector smoothly enters the cam groove 82 without positioning of the lever 7. By rotating the lever 7 to the fitting-completion position while the cam protrusion enters the cam groove 82, the connector main body 4 and the mating connector are brought close to each other.

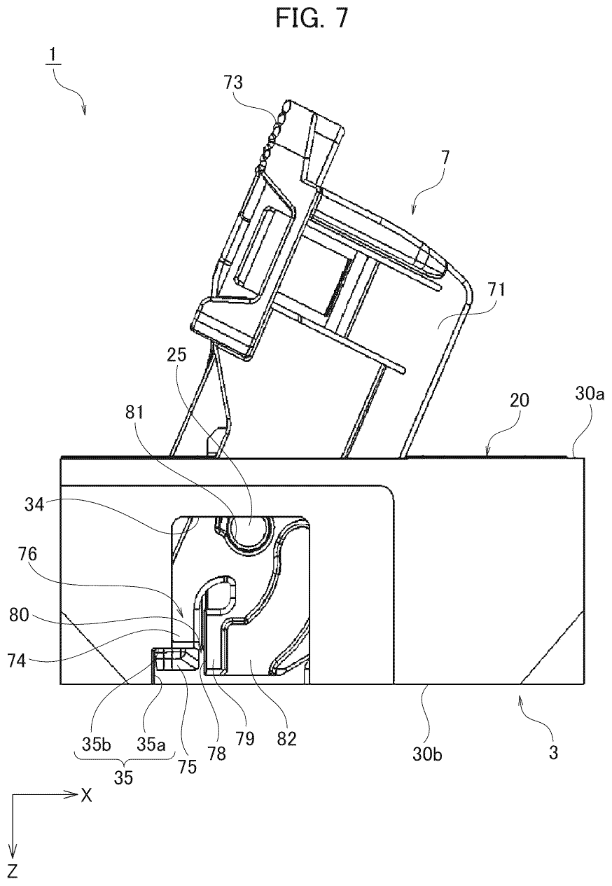

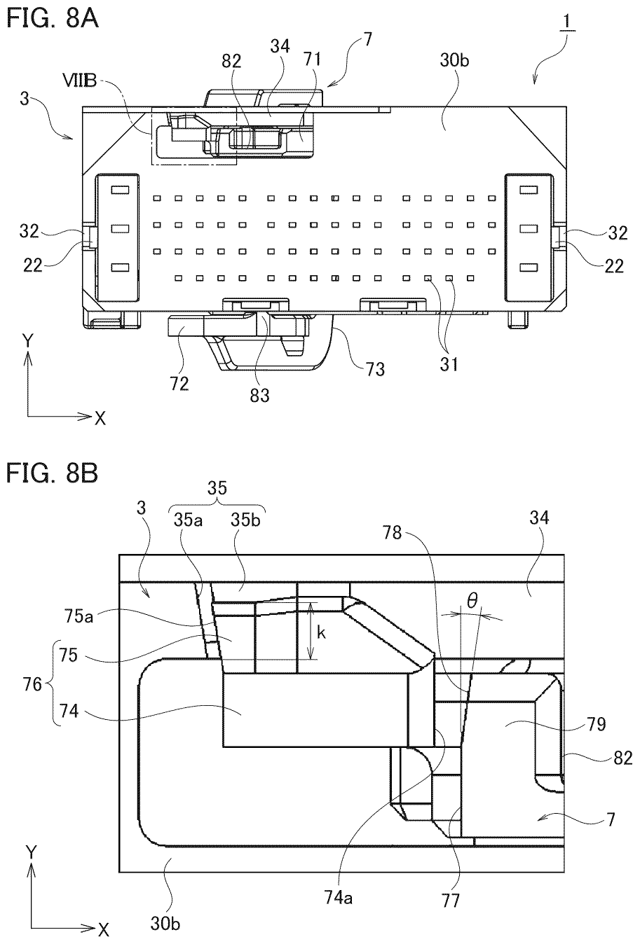

FIG. 7 is a side view of the connector 1 as viewed in a direction opposite to the Y direction when the lever 7 is held at the initial position. FIG. 8A is a bottom view of the connector 1 as viewed in a direction opposite to the Z direction when the lever 7 is held at the initial position. FIG. 8B is an enlarged view of a part of the connector 1 that corresponds to the part VIIIB in FIG. 8A, where the end portion of each of the temporary locking arm 76 and the deflection restricting portion 79 can be visually recognized.

The temporary locking arm 76 holds the lever 7 at the initial position. The temporary locking arm 76 includes an arm portion 74 that deflects toward the second side plate 72, and the protrusion 75 that protrudes from a free end of the arm portion 74 to a side opposite to the second side plate 72. In the present embodiment, the arm portion 74 is formed in a cantilever shape by forming a notch 80 in the first side plate 71.

First, the temporary locking arm 76 restricts rotation of the lever 7 by causing the protrusion 75 to abut against the locking portion 35 provided to the opening portion 34 of the front mask 3, and holds the lever 7 at the initial position. In the present embodiment, the locking portion 35 includes the first edge portion 35a and the second edge portion 35b, and a part of the protrusion 75 abuts against the second edge portion 35b so as to hold the lever 7 at the initial position. In this state, the protrusion 75 abutting against the second edge portion 35b is exposed outside in the Y direction through the opening portion 34, and is also exposed outside in the Z direction. When the lever 7 is at the initial position, the arm portion 74 is in a natural state without elastic deformation while maintaining a posture substantially along the Z direction. Further, as illustrated in FIG. 8B, the temporary locking arm 76 has an engagement margin k with the second edge portion 35b, which is a part of the side edge portion of the opening portion 34, and hence the lever 7 is held at the initial position.

In contrast, when the arm portion 74 deflects toward the second side plate 72, and the protrusion 75 is disengaged from the locking portion 35, the temporary locking arm 76 enables rotation of the lever 7. When fitting of the connector main body 4 with respect to the mating connector is started, a part of the mating connector presses the protrusion 75 toward the second side plate 72. With this, the protrusion 75 is disengaged from the locking portion 35, that is, the opening portion 34, and the lever 7 finally arrives at the fitting-completion position.

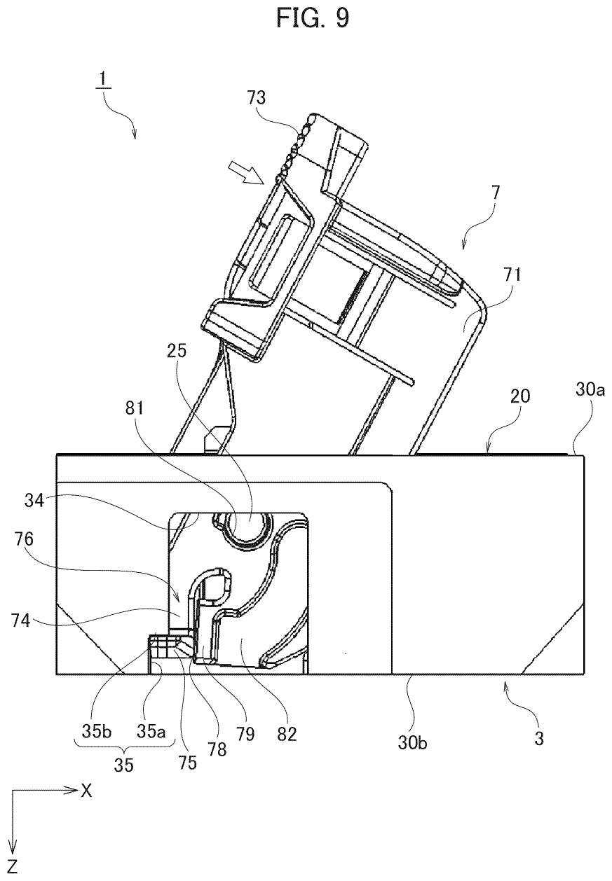

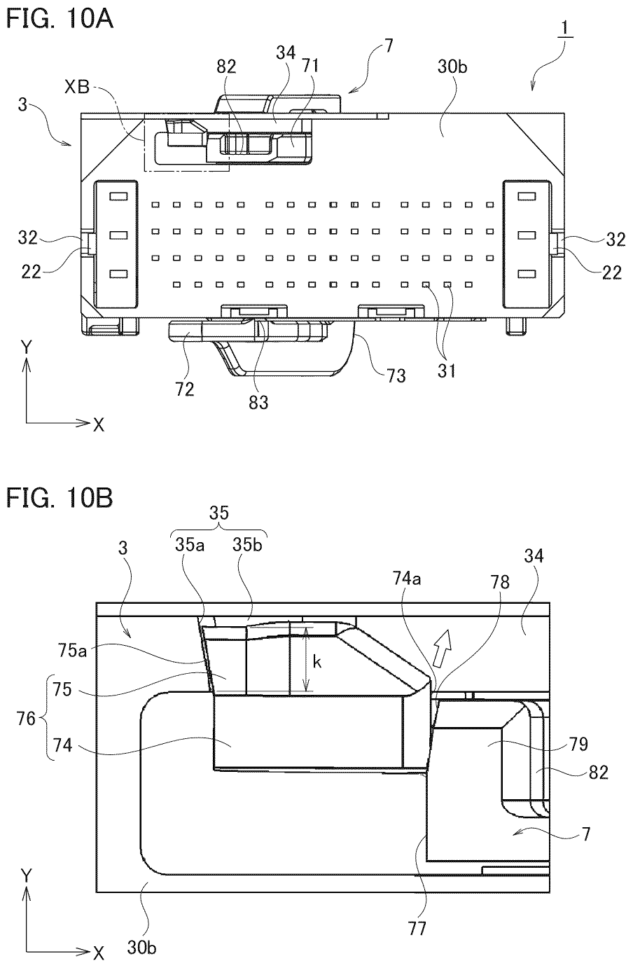

FIG. 9 is a side view of the connector 1 as viewed in a direction opposite to the Y direction when an external force is applied to the lever 7 positioned at the initial position. In FIG. 9, a direction in which an external force is unintentionally applied to the lever 7, which is assumed as an example, is indicated by the white arrow. FIG. 10A is a bottom view of the connector 1 as viewed in a direction opposite to the Z direction when an external force is applied to the lever 7 positioned at the initial position. FIG. 10B is an enlarged view of a part of the connector 1 that corresponds to the part XB in FIG. 10A, where the end portion of each of the temporary locking arm 76 and the deflection restricting portion 79 can be visually recognized.

The deflection restricting portion 79 is arranged adjacent to the temporary locking arm 76 via the notch 80 in the lever 7, and restricts deflection of the arm portion 74 toward the second side plate 72 when an unintended external force is applied to the lever 7 positioned at the initial position. In the present embodiment, the deflection restricting portion 79 includes a deflection restricting surface 78.

As illustrated in FIG. 8B, when the lever 7 is at the initial position, in other words, the temporary locking arm 76 is in a natural state, the deflection restricting surface 78 faces the arm portion 74 via the notch 80. Further, as illustrated in FIG. 10B, the deflection restricting surface 78 contacts with the arm portion 74 of the temporary locking arm 76 deformed by application of an external force to the lever 7 positioned at the initial position.

Further, the deflection restricting surface 78 is inclined so that an interval between the deflection restricting surface 78 and the arm portion 74 is increased as the deflection restricting surface 78 is separated from the second side plate 72 along a direction in which the first side plate 71 and the second side plate 72 face each other. In the present embodiment, the direction in which the deflection restricting surface 78 is separated from the second side plate 72 along the direction in which the first side plate 71 and the second side plate 72 face each other corresponds to the Y direction. Note that, in the deflection restricting portion 79, the deflection restricting surface 78 is not necessarily an entire surface on the side of the notch 80, and a surface that does not face the arm portion 74 may be, for example, a non-inclined surface 77 that is a plane along the Y direction. As an example, FIG. 8B illustrates the deflection restricting surface 78 that is inclined with respect to the non-inclined surface 77 at an inclination angle θ.

With reference to FIG. 10B, when an external force is applied to the lever 7 positioned at the initial position as in the example, first, a side end portion 75a of the protrusion 75 facing the first edge portion 35a abuts against the first edge portion 35a of the locking portion 35 of the front mask 3. With this, the temporary locking arm 76 is deformed, and a part of an inner surface 74a of the arm portion 74 abuts against the deflection restricting surface 78. In this state, the deflection restricting surface 78 is an inclined surface defined as described above, and hence the arm portion 74 is guided by the deflection restricting surface 78, and is displaced in the direction away from the second side plate 72 as indicated by the white arrow in FIG. 10B. In other words, when an external force is applied to the lever 7 as described above, deflection of the arm portion 74 toward the second side plate 72 can be suppressed.

Next, effects of the connector 1 are described.

The connector 1 includes the connector main body 4 that includes at least the inner housing 2 and the front mask 3 accommodating the inner housing 2. Further, the connector 1 includes the lever 7 that is rotatably supported by the inner housing 2, and brings the connector main body 4 close to and fits the connector main body 4 to the mating connector by rotating from the initial position to the fitting-completion position. The lever 7 includes the first side plate 71 and the second side plate 72 that each include the rotation fulcrum portion at the one end side position the inner housing 2 therebetween, and each have an arm-like shape, and the operation portion 73 that couples the other end of the first side plate 71 and the other end of the second side plate 72 to each other. The front mask 3 includes the opening portion 34 from which the one end of the first side plate 71 entering a space between the front mask 3 and the inner housing 2 is exposed outside. The first side plate 71 includes, at the one end side, the temporary locking arm 76 and the deflection restricting portion 79. The temporary locking arm 76 includes the arm portion 74 that deflects toward the second side plate 72, and the protrusion 75 that protrudes from the free end of the arm portion 74 to the side opposite to the second side plate 72. When the protrusion 75 abuts against the locking portion 35 provided to the opening portion 34 of the front mask 3 while the lever 7 is positioned at the initial position, the temporary locking arm 76 restricts rotation of the lever 7. Further, when the arm portion 74 deflects toward the second side plate 72, and the protrusion 75 is disengaged from the locking portion 35, the temporary locking arm 76 enables rotation of the lever 7. The deflection restricting portion 79 includes the deflection restricting surface 78 that contacts with the arm portion 74 of the temporary locking arm 76 deformed by application of an external force to the lever 7 positioned at the initial position. The deflection restricting surface 78 is inclined so that the interval between the deflection restricting surface 78 and the arm portion 74 is increased as the deflection restricting surface 78 is separated from the second side plate 72 along the direction in which the first side plate 71 and the second side plate 72 face each other.

Herein, with regard to the lever 7, in the above-mentioned example, the rotation fulcrum portion provided on the one end side of the first side plate 71 corresponds to the first rotation fulcrum portion 81, and the rotation fulcrum portion provided on the one end side of the second side plate 72 corresponds to the second rotation fulcrum portion 83.

First, in the connector 1, the lever 7 includes the temporary locking arm 76, and hence the lever 7 can be held at the initial position at the time of shipping of the connector 1 or the like.

Further, in the connector 1, the lever 7 includes the deflection restricting portion 79 including the deflection restricting surface 78 inclined as defined above. Thus, as described with reference to FIG. 10B, even when an unintended external force in a direction of rotation toward the fitting-completion position is applied to the lever 7 held at the initial position at the time of shipping of the connector 1 or the like, deflection of the arm portion 74 toward the second side plate 72 can be suppressed.

Herein, as a comparative example, a case is assumed where the lever 7 is not provided with the deflection restricting surface 78, and, for example, the entire surface on the side facing the notch 80 in the lever 7 is a plane surface along the direction in which the first side plate 71 and the second side plate 72 face each other, similarly to the non-inclined surface 77. In such a case, when an unintended external force is applied to the lever 7 as described above, the arm portion 74 abutting against the plane surface may deflect toward the second side plate 72. Deflection of the arm portion 74 in such a direction leads to a decrease in the engagement margin k. Ultimately, when the decrease amount of the engagement margin k exceeds an allowable range, engagement of the temporary locking arm 76 is unintentionally released, which is undesirable.

In contrast, according to the connector 1, even when an unintended external force is applied to the lever 7, deflection of the arm portion 74 toward the second side plate 72 is suppressed. Thus, the reduction of the engagement margin k can be suppressed, and accordingly, release of engagement of the temporary locking arm 76 can be suppressed.

Moreover, in the connector 1, in the lever 7, only the deflection restricting surface 78 being an inclined surface is provided as the structure for suppressing deflection of the arm portion 74 toward the second side plate 72 when an unintended external force is applied to the lever 7. Therefore, according to the connector 1, complication of the deflection restricting portion 79 can be avoided. Thus, the shape of the lever 7 can further be simplified, which is advantageous for reducing the manufacturing cost of the connector 1 and the like.

As described above, according to the present embodiment, it is possible to provide the connector 1 that suppresses release of temporary locking due to application of an unintended external force to the lever 7 held at the initial position by the temporary locking arm 76, with a simpler shape of the lever 7.

Further, in the connector 1, the arm portion 74 of the temporary locking arm 76 may be formed in a cantilever shape by forming the notch 80 in the first side plate 71. The deflection restricting portion 79 may be arranged adjacent to the temporary locking arm 76 via the notch 80.

According to the connector 1, in the lever 7, the temporary locking arm 76 and the deflection restricting portion 79 can be formed by forming the notch 80 in the first side plate 71, and complication of the shape of the lever 7 can be further avoided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector comprising:
a connector main body that includes at least an inner housing and a front mask accommodating the inner housing; and
a lever that is rotatably supported by the inner housing, and brings the connector main body close to and fits the connector main body to a mating connector by rotating from an initial position to a fitting-completion position, wherein the lever includes a first side plate and a second side plate that each include a rotation fulcrum portion at one end side, position the inner housing therebetween, and each have an arm-like shape, and an operation portion that couples the other end of the first side plate and the other end of the second side plate to each other,
the front mask includes an opening portion from which the one end of the first side plate entering a space between the front mask and the inner housing is exposed outside,
the first side plate includes, at the one end side:
a temporary locking arm that includes an arm portion deflecting toward the second side plate and a protrusion protruding from a free end of the arm portion to a side opposite to the second side plate, restricts rotation of the lever when the protrusion abuts against a locking portion provided to the opening portion of the front mask while the lever is positioned at the initial position, and enables rotation of the lever when the arm portion deflects toward the second side plate, and the protrusion is disengaged from the locking portion; and
a deflection restricting portion that includes a deflection restricting surface contacting with the arm portion of the temporary locking arm deformed by application of an external force to the lever positioned at the initial position, and
the deflection restricting surface is inclined so that an interval between the deflection restricting surface and the arm portion is increased as the deflection restricting surface is separated from the second side plate along a direction in which the first side plate and the second side plate face each other.

2. The connector according to claim 1, wherein
the arm portion of the temporary locking arm is formed in a cantilever shape by forming a notch in the first side plate, and
the deflection restricting portion is arranged adjacent to the temporary locking arm with the notch interposed therebetween.
